(19) United States
(12) Patent Application Publication
(10) Pub. No.: US 2025/0123547 A1
(43) Pub. Date: Apr. 17, 2025

(54) ILLUMINATING DEVICE

(71) Applicant: Qisda Corporation, Taoyuan City (TW)

(72) Inventors: Chih Ming Hu, Taoyuan City (TW); Ching-Tze Huang, Taoyuan City (TW)

(73) Assignee: Qisda Corporation, Taoyuan City (TW)

(21) Appl. No.: 18/908,786

(22) Filed: Oct. 7, 2024

(30) Foreign Application Priority Data
Oct. 13, 2023 (TW) 112139106

(51) Int. Cl. G03B 21/20; G03B 17/54; H04N 9/31

(52) U.S. Cl. CPC G03B 21/208; G03B 17/54; G03B 21/2033; H04N 9/3179

(57) ABSTRACT

An illuminating device includes: a projection device, a light receiving device and a processor. The projection device includes: a light source configured to generate a light beam; a photogate device located on an optical path of the light beam, the photogate gate device includes a first photogate located on the light incident surface of the photogate device; and a second photogate located on the light exit surface of the photogate device. The light receiving device is configured to sense a first image light and a second image light of the object to be detected through a sensing path when the first structured light and the second structured light are projected to the object to be detected. The processor is coupled to the light receiving device for analyzing the first image and the second image of the object to be detected.

### CROSS-REFERENCE TO RELATED APPLICATION

This application claims the priority benefit of Taiwan application serial no. 112139106, filed on Oct. 13, 2023. The entirety of the above-mentioned patent application is hereby incorporated by reference herein and made a part of specification.

### BACKGROUND

### Technical Field

The present disclosure relates to an illuminating device.

### Description of Related Art

An intraoral scanner system is operated based on the principle of generating a structured light to illuminate a target object, and collect the image light reflected by the target object (such as teeth) to establish a 3D surface model of the target object. A good intraoral scanner may provide a large depth of field (DOF). When scanning the oral cavity, an intraoral scanner with a large DOF is able to provide excellent images of the deep roots of teeth or molars that are difficult to access with the front end of the intraoral scanner, thereby maintaining the accuracy of the entire mouth.

In order to improve the DOF of the intraoral scanner, commonly used techniques include changing the size of the lens aperture in the intraoral scanner system. The deeper the DOF, the smaller the lens aperture; therefore, in order to increase the DOF, it will be necessary to reduce the aperture size. However, such method will compromise the overall light intensity, resulting in a decrease in resolution. Therefore, how to maintain system brightness and increase DOF has always been an important issue in the field of intraoral scanners.

### SUMMARY

The present disclosure provides an illuminating device for simultaneously generating structured light with different depths of field (DOF).

An illuminating device of the present disclosure includes: a projection device, the projection device includes: a light source configured to generate a light beam; a photogate device located on an optical path of the light beam, the photogate device includes: a first photogate located on the light incident surface of the photogate device; and a second photogate located on the light exit surface of the photogate device, wherein the light beam passes through the first photogate and the second photogate in sequence, the light beam passes through the first photogate to generate a first structured light, the light beam passes through the second photogate to generate a second structured light, the first structured light and the second structured light are projected to the object to be detected through a projection path; a light receiving device configured to sense a first image light and a second image light of the object to be detected through a sensing path when the first structured light and the second structured light are projected to the object to be detected; a processor coupled to the light receiving device for analyzing the first image and the second image of the object to be detected, the first image corresponds to the first image light of the object to be detected, and the second image corresponds to the second image light of the object to be detected.

According to some embodiments, the first structured light has a first DOF, and the second structured light has a second DOF that is different from the first DOF.

According to some embodiments, the first photogate includes a first pattern area and a second pattern area, the second photogate includes a third pattern area and a fourth pattern area, and the first part of the light beam passes through the first pattern area and the third pattern area to generate the first structured light, and the second part of the light beam passes through the second pattern area and the fourth pattern area to generate the second structured light.

According to some embodiments, the first pattern area has a first pattern to generate the first structured light, and the fourth pattern area has a second pattern to generate the second structured light, the second pattern area and the third pattern area allow the light beam to pass through.

According to some embodiments, the first pattern and the second pattern are the same patterns.

According to some embodiments, the first pattern and the second pattern are stripe patterns perpendicular to the optical path direction.

According to some embodiments, the extending direction of the first pattern is parallel or perpendicular to the extending direction of the second pattern.

According to some embodiments, a gap of the stripe pattern of the first pattern is the same as a gap of the stripe pattern of the second pattern.

According to some embodiments, the first pattern and the second pattern are different patterns.

According to some embodiments, the first photogate includes a first plurality of beam-transmissible areas and a first plurality of beam-impermeable areas, and the second photogate includes a second plurality of beam-transmissible areas, a third plurality of beam-transmissible areas and a second plurality of beam-impermeable areas. The width of each of the first plurality of beam-transmissible areas is a first width, the width of each of the second plurality of beam-transmissible areas is a second width, and the width of each of the third plurality of beam-transmissible areas is a third width, wherein the second width is greater than the first width, the third width is less than the first width, and the first part of the light beam passes through the first plurality of beam-transmissible areas and the second plurality of beam-transmissible areas to generate the first structured light, the second part of the light beam passes through the first plurality of beam-transmissible areas and the third plurality of beam-transmissible areas to generate the second structured light.

According to some embodiments, the ratio of the second width to the first width is greater than or equal to 1.2, and the ratio of the third width to the first width is less than or equal to 0.8.

According to some embodiments, the widths of each of the first plurality of beam-impermeable areas and the second plurality of beam-impermeable areas are the same.

According to some embodiments, the widths of each of the first plurality of beam-impermeable areas and the second plurality of beam-impermeable areas are the first width.

According to some embodiments, each of the second plurality of beam-transmissible areas is staggered with each of the third plurality of beam-transmissible areas.

According to some embodiments, the first photogate includes the first plurality of beam-transmissible areas, the second plurality of beam-transmissible areas and the first plurality of beam-impermeable areas, and the second photogate includes the third plurality of beam-transmissible areas and the second plurality of beam-impermeable areas, wherein the width of each of the first plurality of beam-transmissible areas is a first width, and the width of each of the second plurality of beam-transmissible areas is a second width, the width of each of the third plurality of beam-transmissible areas is a third width, wherein the first width is less than the third width, the second width is greater than the third width, the first part of the light beam passes through the first plurality of beam-transmissible areas and the third plurality of beam-transmissible areas to generate the first structured light, and the second part of the light beam passes through the second plurality of beam-transmissible areas and the third plurality of beam-transmissible areas to generate the second structured light.

According to some embodiments, the widths of each of the first plurality of beam-impermeable areas and the second plurality of beam-impermeable areas are the same.

According to some embodiments, the widths of each of the first plurality of beam-impermeable areas and the second plurality of beam-impermeable areas are the third width.

According to some embodiments, each of the first plurality of beam-transmissible areas is staggered with each of the second plurality of beam-transmissible areas.

According to some embodiments, the thickness of the photogate device in the optical path direction is 0.5 mm to 2 mm.

According to some embodiments, the light beam may be infrared light, red light, green light, blue light, near-ultraviolet light, ultraviolet light, or white light.

Based on the above, with two photogates located at different positions, a single light source may be used to simultaneously generate two structured lights with different DOFs. Therefore, there is no need to reduce the aperture inside the projection lens, and the DOF of the system may be improved while maintaining brightness.

### BRIEF DESCRIPTION OF THE DRAWINGS

FIG. 1 is a schematic diagram of an illuminating device according to an embodiment of the present disclosure.

FIG. 2A is a schematic diagram of a projection device according to an embodiment of the present disclosure.

FIG. 2B is a schematic diagram of a first photogate according to an embodiment of the present disclosure.

FIG. 2C is a schematic diagram of a second photogate according to an embodiment of the present disclosure.

FIG. 2D is a schematic diagram of generating a first structured light and a second structured light according to an embodiment of the present disclosure.

FIG. 3A is a schematic diagram of a projection device according to an embodiment of the present disclosure.

FIG. 3B is a schematic diagram of a first photogate according to an embodiment of the present disclosure.

FIG. 3C is a schematic diagram of a second photogate according to an embodiment of the present disclosure.

FIG. 4A is a schematic diagram of a projection device according to an embodiment of the present disclosure.

FIG. 4B is a schematic diagram of a first photogate according to an embodiment of the present disclosure.

FIG. 4C is a schematic diagram of a second photogate according to an embodiment of the present disclosure.

FIG. 4D is a schematic diagram of generating a first structured light and a second structured light according to an embodiment of the present disclosure.

FIG. 5A is a schematic diagram of a projection device according to an embodiment of the present disclosure.

FIG. 5B is a schematic diagram of a first photogate according to an embodiment of the present disclosure.

FIG. 5C is a schematic diagram of a second photogate according to an embodiment of the present disclosure.

FIG. 5D is a schematic diagram of generating a first structured light and a second structured light according to an embodiment of the present disclosure.

FIG. 6A is a schematic diagram of a projection device according to an embodiment of the present disclosure.

FIG. 6B is a schematic diagram of a first photogate according to an embodiment of the present disclosure.

FIG. 6C is a schematic diagram of a second photogate according to an embodiment of the present disclosure.

FIG. 6D is a schematic diagram of generating a first structured light and a second structured light according to an embodiment of the present disclosure.

### DESCRIPTION OF THE EMBODIMENTS

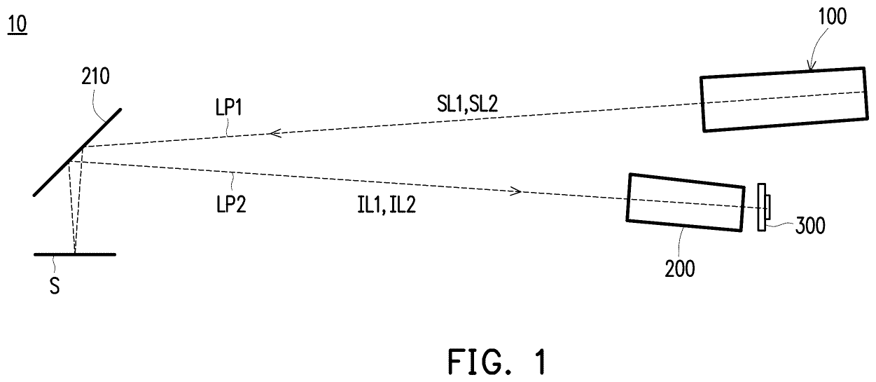

FIG. 1 is a schematic diagram of an illuminating device according to an embodiment of the present disclosure. The illuminating device 10 includes: a projection device 100, a light receiving device 200, and a processor 300.

The projection device 100 is configured to generate the light beam L and convert the light beam L into the first structured light SL1 and the second structured light SL2, and project the first structured light SL1 and the second structured light SL2 to the object S to be detected. The specific structure of the projection device 100 will be described below.

The first structured light SL1 and the second structured light SL2 emitted by the projection device 100 are incident on the reflector 210 through the projection path LP1, reflected by the reflector 210, and then projected to the object S to be detected. In some embodiments, the reflector 210 may be a mirror, or an optical element with a metal reflective coating, or other devices with similar functions, but the disclosure is not limited thereto. In some embodiments, the object S to be detected is a tooth.

When the first structured light SL1 and the second structured light SL2 are projected to the object S to be detected, the first structured light SL1 and the second structured light SL2 are reflected by the object S to be detected, thereby forming the first image light IL1 and the second image light IL2. The first image light IL1 and the second image light IL2 are incident on the reflector 210 and are reflected by the reflector 210, and then incident on the light receiving device 200 along the sensing path LP2.

The light receiving device 200 is located on the optical path of the sensing path LP2. When the first structured light SL1 and the second structured light SL2 are projected onto the object S to be detected, the first image light IL1 and the second image light IL2 of the object S to be detected are sensed through the sensing path LP2. According to some embodiments, the light receiving device 200 may be regarded as a camera module, such as a single camera module or a multi-camera module. In some embodiments, the light receiving device 200 includes a filter, such as a band pass filter which allows the first image light IL1 and the second image light IL2 with a prescribed wavelength range to pass through and filters out light beams in other wavelength ranges. The prescribed wavelength range is, for example, the peak wavelength of the spectrum of light beam L. Through the setting of the filter, it is possible to prevent other noises from entering the light receiving device 200 to ensure detection quality. In some embodiments, the light receiving device 200 includes, for example, an optoelectronic element that may convert an optical signal into an electrical signal, such as a complementary metal-oxide semiconductor (CMOS), a charge-coupled element (CCD), a photomultiplier (PMT) or an avalanche photodiode (APD). Preferably, the type of the light receiving device 200 may be CMOS or CCD, but is not limited thereto.

The processor 300, coupled to the light receiving device 200, is configured to analyze the first image I1 and the second image I2 of the object S to be detected, wherein the first image I1 corresponds to the first image light IL1 of the object S to be detected, and the second image I2 corresponds to the second image light IL2 of the object S to be detected. In some embodiments, the processor 300 may include a calculator, a microprocessor, a central processing unit (CPU), or other programmable controllers, a digital signal processor (DSP), application specific integrated circuits (ASIC), a programmable logic device (PLD) or other similar devices.

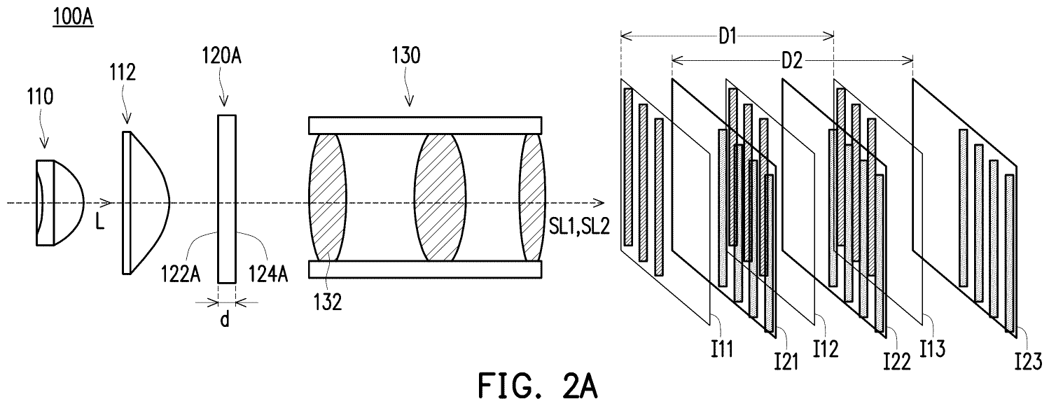

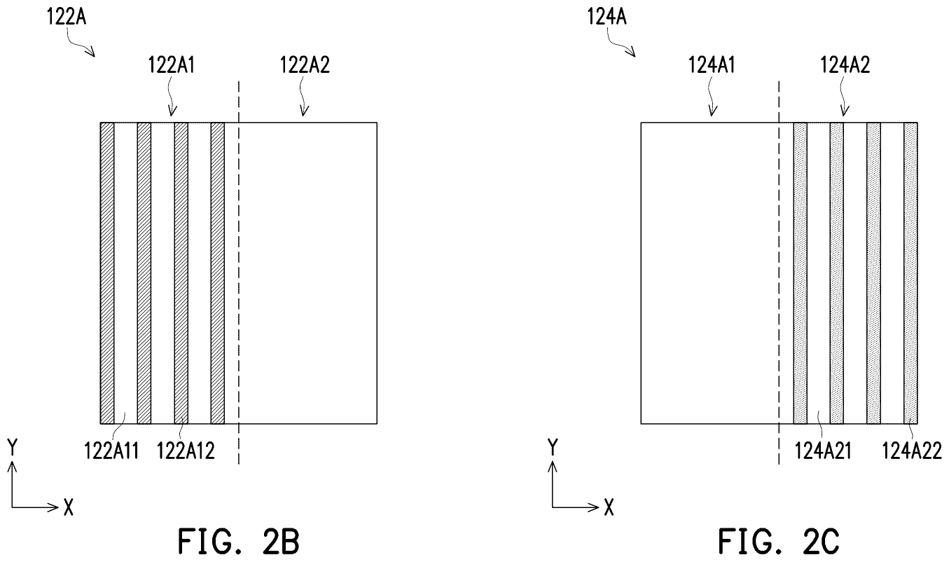

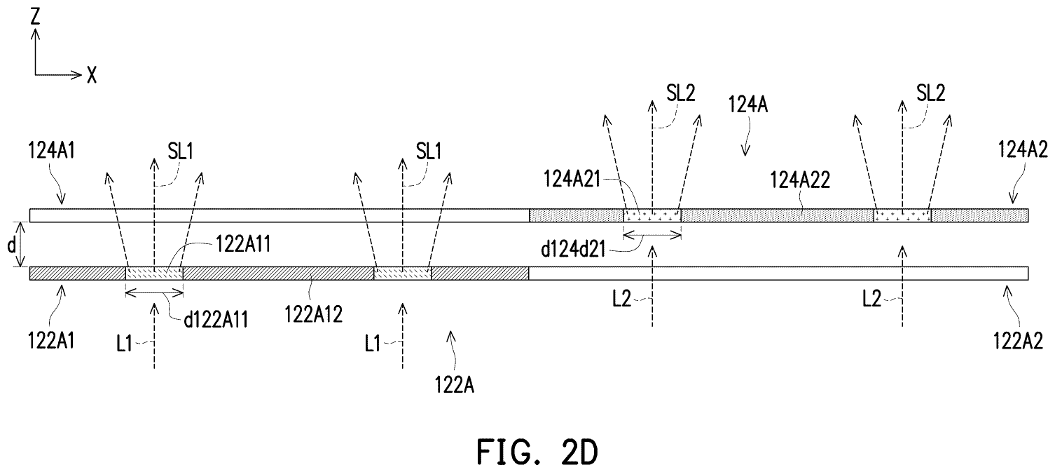

FIG. 2A is a schematic diagram of a projection device according to an embodiment of the present disclosure. The projection device 100A is an embodiment of the projection device 100 in FIG. 1. As shown in FIG. 2, the projection device 100A includes: a light source 110, a photogate device 120A, and a projection lens assembly 130.

The light source 110 is configured to generate a light beam L, and the light beam L passes through the lens 112 and then is incident on the photogate device 120A. According to some embodiments, the light source 110 may be a light emitting diode, a Mini LED, a Micro LED, an organic light emitting diode, a laser diode or other suitable light emitting components, the disclosure is not limited thereto. In some embodiments, the light beam L may be infrared light, red light, green light, blue light, near-ultraviolet light, ultraviolet light, white light, or light in other wavelength ranges, but the disclosure is not limited thereto.

The photogate device 120A is located on the optical path of the light beam L. In some embodiments, the photogate device 120A is a transparent optical element for allowing the light beam L to pass through and generating the first structured light SL1 and the second structured light SL2. In some embodiments, the photogate device 120A may be made of glass or other materials with similar properties, but the present disclosure is not limited thereto. As shown in FIG. 2A, the photogate device 120A has a thickness d. The thickness d of the photogate device 120A may cause the first structured light SL1 and the second structured light L2 to produce different depths of field (DOF), so the thickness d needs to be set within a certain range. If the thickness d is too small, the difference in DOF between the first structured light and the second structured light will not be obvious. If the thickness d is too large, the first structured light SL1 and the second structured light SL2 will lose energy in the photogate device 120A, resulting in a decrease in resolution. In some embodiments, the thickness d of the photogate device 120A is 0.5 mm to 2 mm, but the disclosure is not limited thereto.

The photogate device 120A includes: a first photogate 122A and a second photogate 124A. The first photogate 122A is located on the light incident surface of the photogate device 120A, and the second photogate 124A is located on the light exit surface of the photogate device 120A. The light beam L passes through the first photogate 122A and the second photogate 124A in sequence. The light beam L passes through the first photogate 122A to generate the first structured light SL1, and the light beam L passes through the second photogate 124A to generate the second structured light SL2.

In some embodiments, an opaque material is electroplated on the light incident surface and the light exit surface of the photogate device 120A, that is, on the two opposite surfaces located on the optical path of the light beam L to form the first photogate 122A and the second photogate 124A. In some embodiments, the materials of the first photogate 122A and the second photogate 124A may be opaque metal materials, such as chromium, or other materials with similar properties, but the disclosure is not limited thereto.

The first structured light SL1 and the second structured light SL2 generate the first images I11, I12 and I13 with the first DOF D1 and the second images I21, I22 and I23 with the second DOF D2 different from the first DOF D1, and are projected to the object S to be detected through the projection path LP1.

Specifically, the light beam L passes through the first photogate 122A located on the light incident surface of the photogate device 120A to form the first structured light SL1, and then forms the first images I11, I12, and I13. The light beam L passes through the second photogate 124A located on the light exit surface of the photogate device 120A to form the second structured light SL2, and then forms the second images I21, I22, and I23. Since the first structured light SL1 is generated on the light incident surface of the photogate device 120A, which is the upstream of the optical path, and the second structured light SL2 is generated on the light exit surface of the photogate device 120A, which is the downstream of the optical path, the first images I11, I12, and I13 are located upstream of the optical path compared to the second images I21, I22, and I23. In this way, the light beam L may simultaneously generate the first images I11, I12, and I13 and the second images I21, I22, and I23 with different DOFs.

As shown in FIG. 2A, in some embodiments, the projection device 100A further includes a projection lens assembly 130. The projection lens assembly 130 is located on the optical path of the first structured light SL1 and the second structured light SL2, and is located downstream of the photogate device 120A. In some embodiments, the projection lens assembly 130 is a combination of one or more optical lenses 132 having diopter. The optical lenses 132 include, for example, biconcave lenses, biconvex lenses, meniscus lenses, convex-concave lenses, plano-convex lenses, plano-concave lenses and combinations of other non-planar lenses. This disclosure does not limit the form and type of the projection lens assembly 130. In some embodiments, the projection device 100A may not include the projection lens assembly 130, and the present disclosure is not limited thereto.

FIG. 2B is a schematic diagram of a first photogate according to an embodiment of the present disclosure. FIG. 2C is a schematic diagram of a second photogate according to an embodiment of the present disclosure. FIG. 2D is a schematic diagram of generating a first structured light and a second structured light according to an embodiment of the present disclosure. Please refer to FIG. 2B, FIG. 2C, and FIG. 2D at the same time.

As shown in FIG. 2B, the first photogate 122A includes a first pattern area 122A1 and a second pattern area 122A2. The first pattern area 122A1 and the second pattern area 122A2 are respectively located on both sides of the first photogate 122A. In some embodiments, the first pattern area 122A1 and the second pattern area 122A2 have the same size.

As shown in FIG. 2C, the second photogate 124A includes a third pattern area 124A1 and a fourth pattern area 124A2. The third pattern area 124A1 and the fourth pattern area 124A2 are respectively located on both sides of the second photogate 124A. In some embodiments, the third pattern area 124A1 and the fourth pattern area 124A2 have the same size.

In some embodiments, the first pattern area 122A1 and the third pattern area 124A1 are located on the same side of the projection along the optical path direction of the light beam L, and the second pattern area 122A2 and the fourth pattern area 124A2 are located the other side of the projection along the optical path direction of the light beam L.

As shown in FIG. 2B, the first pattern area 122A1 of the first photogate 122A has a first pattern which generates the first structured light SL1 when the light beam L passes through. The first pattern includes a first plurality of beam-transmissible areas 122A11, and a first plurality of beam-impermeable areas 122A12. The first plurality of beam-transmissible areas 122A11 and the first plurality of beam-impermeable areas 122A12 are staggered.

As shown in FIG. 2B, the second pattern area 122A2 of the first photogate 122A does not have any pattern. The second pattern area 122A2 is transparent relative to the light beam L and allows the light beam L to pass through.

As shown in FIG. 2C, the third pattern area 124A1 of the second photogate 124A does not have any pattern. The third pattern area 124A1 is transparent relative to the light beam L and allows the light beam L to pass through.

As shown in FIG. 2C, the fourth pattern area 124A2 of the second photogate 124A has a second pattern which generates the second structured light SL2 when the light beam L passes through. The second pattern includes a second plurality of beam-transmissible areas 124A21, and a second plurality of beam-impermeable areas 124A22. The second plurality of beam-transmissible areas 124A21 and the second plurality of beam-impermeable areas 124A22 are staggered.

In this embodiment, the first pattern of the first pattern area 122A1 of the first photogate 122A and the second pattern of the fourth pattern area 124A2 of the second photogate 124A are the same patterns. Therefore, when the light beam L passes through the photogate device 120A, the first structured light SL1 and the second structured light SL2 have the same diffraction pattern.

Please refer to FIG. 2B and FIG. 2C at the same time. In some embodiments, the first pattern of the first pattern area 122A1 of the first photogate 122A and the second pattern of the fourth pattern area 124A2 of the second photogate 124A are stripe patterns perpendicular to the optical path direction. In this embodiment, the extending direction of the first pattern is parallel to the extending direction of the second pattern. Specifically, as shown in FIG. 2B and FIG. 2C, the extending direction of the first plurality of beam-impermeable areas 122A12 in the first pattern of the first pattern area 122A1 of the first photogate 122A is parallel with the extending direction of the second plurality of beam-impermeable areas 124A22 in the second pattern of the fourth pattern area 124A2 of the second photogate 124A. Therefore, the diffraction pattern generated by the first structured light SL1 and the diffraction pattern generated by the second structured light SL2 also have the same stripe arrangement direction, that is, the stripe arrangement directions are parallel to each other.

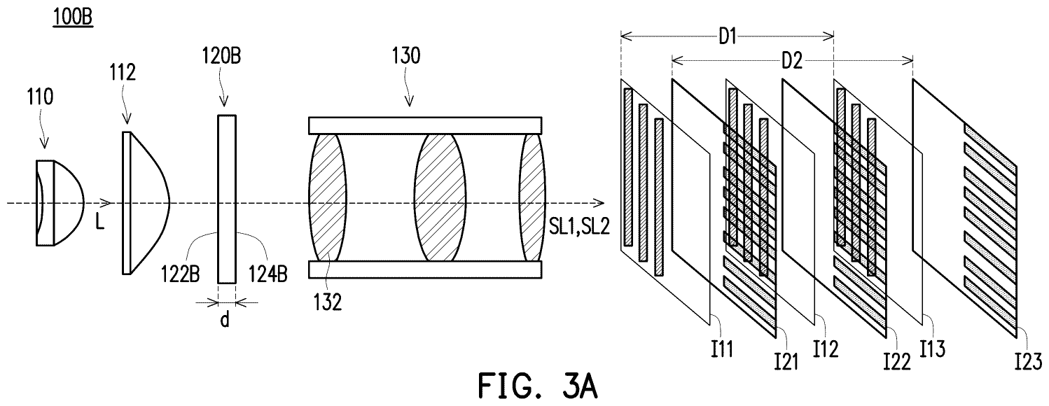

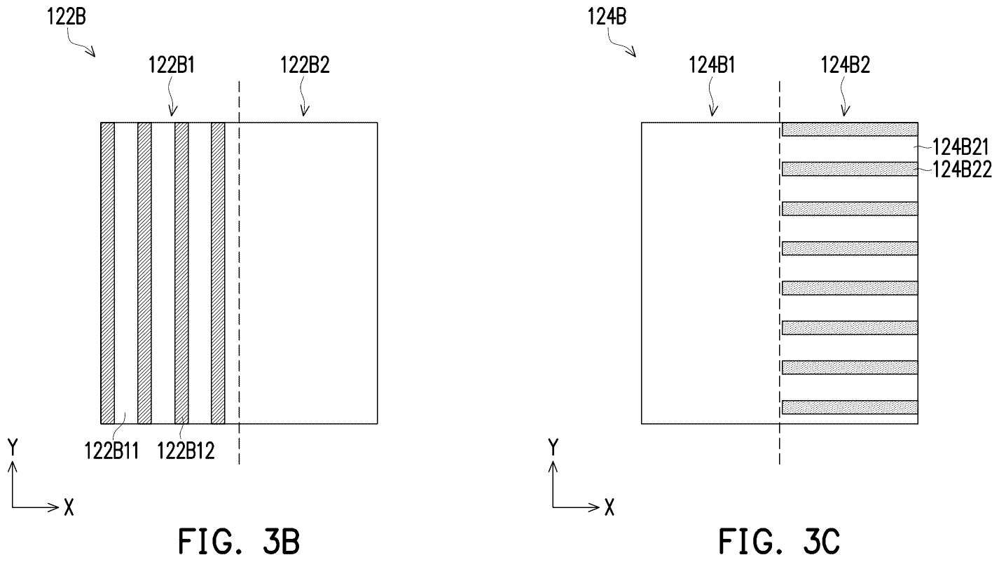

For example, as shown in FIG. 3A, the first images I11, I12, and I13 formed by the first structured light SL1 and the second images I21, I22, and I23 formed by the second structured light SL2 have different diffraction patterns, wherein the stripe directions of the first images I11, I12, and I13 and the stripe directions of the second images I21, I22, and I23 are perpendicular to each other.

Please refer to FIG. 2D. In some embodiments, the gap between the stripe patterns of the first pattern of first pattern area 122A1 of the first photogate 122A, i.e., the width d122A11 of the first plurality of beam-transmissible areas 122A11 is the same as the gap between the stripe patterns of the second pattern of the fourth pattern area 124A2 of the second photogate 124A, i.e., the width d124A21 of the second plurality of beam-transmissible areas 124A21. Therefore, the first structured light SL1 and the second structured light SL2 may have the same diffraction pattern. In other embodiments, the gap of the stripe pattern of the first pattern is different from the gap of the stripe pattern of the second pattern, and the present disclosure is not limited thereto.

Please refer to FIG. 2D. The following describes the formation process of the first structured light SL1 and the second structured light SL2 when the light beam L is incident on the photogate device 120A. When the light beam L is incident on the photogate device 120A, the first partial light beam L1 of the light beam L is incident on the first pattern area 122A1 of the first photogate 122A, thereby generating the first structured light SL1. The generated first structured light SL1 continues to be incident on the third pattern area 124A1 of the second photogate 124A. Since the third pattern area 124A1 does not have any pattern, the first structured light SL1 passes through the third pattern area 124A1 without any influence. The first structured light SL1 exits from the photogate device 120A and proceeds along the projection path LPL.

On the other hand, the second partial light beam L2 of the light beam L is incident on the second pattern area 122A2 of the first photogate 122A. Since the second pattern area 122A2 does not have any pattern, the second partial light beam L2 passes through the second pattern area 122A2 without any influence. The second partial light beam L2 of the light beam L continues to be incident on the fourth pattern area 124A2 of the second photogate 124A and then generates the second structured light SL2. The second structured light SL2 exits from the photogate device 120A and proceeds along the projection path LPL.

Since the first structured light SL1 is formed by the first photogate 122A located on the light incident surface of the photogate device 120A, and the second structured light SL2 is formed by the second photogate 124A located on the light exit surface of the photogate device 120A, the first structured light SL1 has the first DOF D1 and the second structured light SL2 has a second DOF D2 different from the first DOF D1.

Therefore, by using the photogate device 120A as shown in FIG. 2A to FIG. 2D, a single light source may be used to generate two structured lights with different DOFs, thereby improving the sampling efficiency of detecting the sample surface.

FIG. 3A is a schematic diagram of a projection device according to an embodiment of the present disclosure. The projection device 100B is an embodiment of the projection device 100 in FIG. 1. The projection device 100B shown in FIG. 3A is similar to the projection device 100A shown in FIG. 2A, except that the projection device 100B has a different photogate device 120B relative to the projection device 100A. The photogate device 120B has a first photogate 122B and a second photogate 124B. Therefore, the following describes the differences between the photogate device 120B and the photogate device 120A.

FIG. 3B is a schematic diagram of a first photogate according to an embodiment of the present disclosure. FIG. 3C is a schematic diagram of a second photogate according to an embodiment of the present disclosure. Please refer to FIG. 3B and FIG. 3C at the same time.

As shown in FIG. 3B, the first photogate 122B includes a first pattern area 122B1 and a second pattern area 122B2. The first pattern area 122B1 and the second pattern area 122B2 are the same as the first photogate 122A in FIG. 2B, and therefore will not be described again here.

As shown in FIG. 3C, the second photogate 124B includes a third pattern area 124B1 and a fourth pattern area 124B2. The third pattern area 124B1 and the fourth pattern area 124B2 are respectively located on both sides of the second photogate 124B. In some embodiments, the third pattern area 124B1 and the fourth pattern area 124B2 have the same size.

In some embodiments, the first pattern area 122B1 and the third pattern area 124B1 are located on the same side of the projection along the optical path direction of the light beam L, and the second pattern area 122B2 and the fourth pattern area 124B2 are located on the other side of the projection along the optical path direction of the light beam L.

As shown in FIG. 3C, the third pattern area 124A1 of the second photogate 124B does not have any pattern. The third pattern area 124B1 is transparent relative to the light beam L and allows the light beam L to pass through.

As shown in FIG. 3C, the fourth pattern area 124B2 of the second photogate 124B has a second pattern which generates the second structured light SL2 when the light beam L passes through. The second pattern includes a second plurality of beam-transmissible areas 124B21, and a second plurality of beam-impermeable areas 124B22. The second plurality of beam-transmissible areas 124B21 and the second plurality of beam-impermeable areas 124B22 are staggered.

In this embodiment, the first pattern of the first pattern area 122B1 of the first photogate 122B and the second pattern of the fourth pattern area 124B2 of the second photogate 124B are different patterns. Therefore, when the light beam L passes through the photogate device 120B, the first structured light SL1 and the second structured light SL2 have different diffraction patterns.

Please refer to FIG. 3A to FIG. 3C simultaneously. In some embodiments, the first pattern of the first pattern area 122A1 of the first photogate 122A and the second pattern of the second pattern area 122A2 of the second photogate 124A are stripe patterns perpendicular to the optical path direction. In this embodiment, the extending direction of the first pattern is perpendicular to the extending direction of the second pattern. Specifically, as shown in FIG. 3B and FIG. 3C, the extending direction of the first plurality of beam-impermeable areas 122B12 in the first pattern of the third pattern area 122B1 of the first photogate 122B is perpendicular to the extending direction of the second plurality of beam-impermeable areas 124B22 in the second pattern of the fourth pattern area 124B2 of the second photogate 124B. Therefore, the diffraction pattern generated by the first structured light SL1 and the diffraction pattern generated by the second structured light SL2 also have different stripe arrangement directions, that is, the stripe arrangement directions are perpendicular to each other.

For example, as shown in FIG. 3A, the first images I11, I12, and I13 formed by the first structured light SL1 and the second images I21, I22, and I23 formed by the second structured light SL2 have different diffraction patterns, wherein the stripe directions of the first images I11, I12, and I13 and the stripe directions of the second images I21, I22, and I23 are perpendicular to each other.

Therefore, by using the photogate device 120B as shown in FIG. 3A to FIG. 3C, a single light source may be used to generate two structured lights with different DOFs and different diffraction patterns, thereby improving the sampling efficiency of detecting the sample surface, and increasing the resolution efficiency of diffraction patterns with different DOFs.

In the embodiments shown in FIG. 2A to FIG. 2D and FIG. 3A to FIG. 3C, the first structured light and the second structured light are formed by only part of the first photogate and part of the second photogate respectively, and therefore the shape and coverage area of the structured light are significantly restricted. Accordingly, the following embodiment illustrates the method of using a complete first photogate and a second photogate to generate structured light.

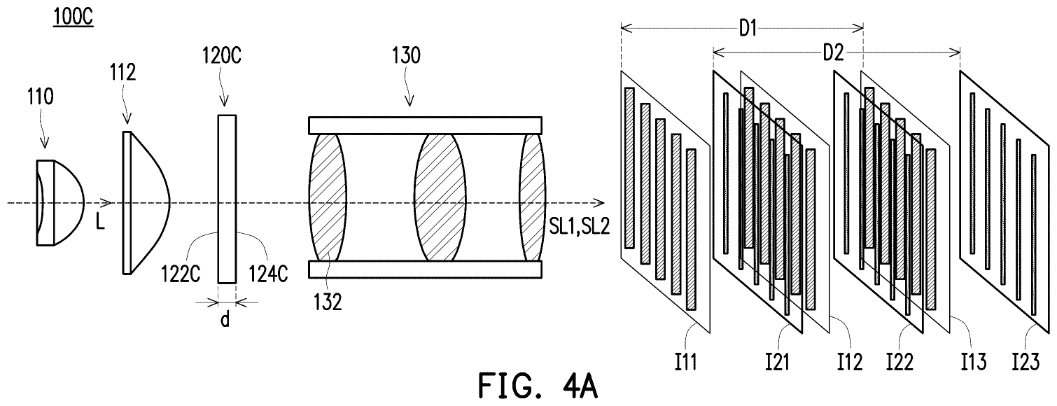

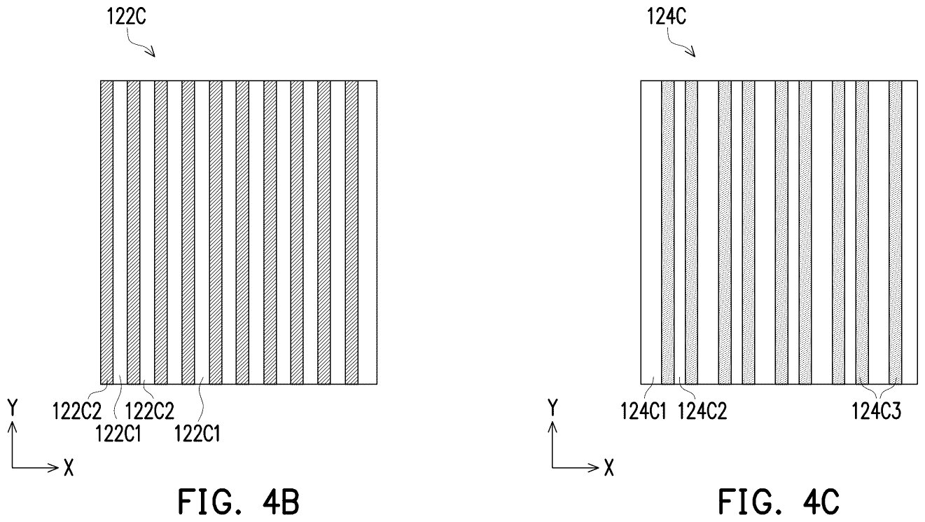

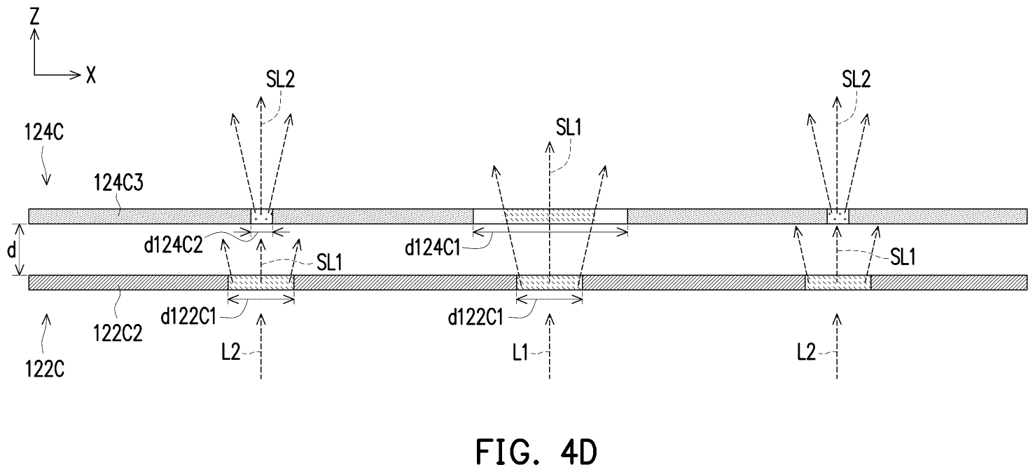

FIG. 4A is a schematic diagram of a projection device according to an embodiment of the present disclosure. The projection device 100C is an embodiment of the projection device 100 in FIG. 1. The projection device 100C shown in FIG. 4A is similar to the projection device 100A shown in FIG. 2A, except that the projection device 100C has a different photogate device 120C relative to the projection device 100A. The photogate device 120C has a first photogate 122C and a second photogate 124C. Therefore, the following description is directed at the photogate device 120C.

FIG. 4B is a schematic diagram of a first photogate according to an embodiment of the present disclosure. FIG. 4C is a schematic diagram of a second photogate according to an embodiment of the present disclosure. FIG. 4D is a schematic diagram of generating a first structured light and a second structured light according to an embodiment of the present disclosure.

Please refer to FIG. 4B, FIG. 4C, and FIG. 4D at the same time. The first photogate 122C has a beam-transmissible area with a single width, and the second photogate 124D has beam-transmissible areas with two different widths. Specifically, the first photogate 122C includes a first plurality of beam-transmissible areas 122C1 and a first plurality of beam-impermeable areas 122C2. The second photogate 124C includes a second plurality of beam-transmissible areas 124C1, a third plurality of beam-transmissible areas 124C2, and a second plurality of beam-impermeable areas 124C3. The width of each of the first plurality of beam-transmissible areas 122C1 is the first width d122C1, the width of each of the second plurality of beam-transmissible areas 124C1 is the second width d124C1, and the width of each of the third plurality of beam-transmissible areas 124C2 is the third width d124C2, wherein the second width d124C1 is greater than the first width d122C1, and the third width d124C2 is less than the first width d122C1.

According to some embodiments, the ratio of the second width d124C1 to the first width d122C1 (d124C1/d122C1) is greater than or equal to 1.2, and the ratio of the third width d124C2 to the first width d122C1 (d124C2/d122C1) is less than or equal to 0.8; however, the present disclosure is not limited thereto, and may have other ratios according to actual application requirements.

Each beam-transmissible area of the second plurality of beam-transmissible areas 124C1 is opposite to one of the first plurality of beam-transmissible areas 122C1, and each beam-transmissible area of the third plurality of beam-transmissible areas 124C2 is opposite to one of the first plurality of beam-transmissible areas 124C1. Therefore, the light beam passing through one of the first plurality of beam-transmissible areas 122C1 may be respectively and correspondingly incident on one beam-transmissible area of the second plurality of beam-transmissible areas 124C1 or the third plurality of beam-transmissible areas 124C2.

In addition, as shown in FIG. 4C, each of the second plurality of beam-transmissible areas 124C1 is staggered with each of the third plurality of beam-transmissible areas 124C2.

In some embodiments, the widths of each of the first plurality of beam-impermeable areas 122C2 of the first photogate 122C and the second plurality of beam-impermeable areas 124C3 of the second photogate 124C are the same. In some embodiments, the widths of each of the first plurality of beam-impermeable areas 122C2 and the second plurality of beam-impermeable areas 124C3 are the first width d122C1, which is the same as the width d122C1 of the first plurality of beam-transmissible areas 122C1 of the first photogate 122C. In other embodiments, the widths of each of the first plurality of beam-impermeable areas 122C2 and the second plurality of beam-impermeable areas 124C3 are the same, but different from the first width d122C1, that is, different from the width d122C1 of the first plurality of beam-transmissible areas 122C1 of the first photogate 122C.

Through the width relationship between the first plurality of beam-transmissible areas 122C1 of the first photogate 122C and the second plurality of beam-transmissible areas 124C1 and the third plurality of beam-transmissible areas 124C2 of the second photogate 124C, it is possible to make the light beam L to generate the first structured light SL1 and the second structured light SL2 with different DOFs. The following description takes FIG. 4D as an example.

Please refer to FIG. 4D. The first partial light beam L1 of the light beam L passes through the first plurality of beam-transmissible areas 122C1 and the second plurality of beam-transmissible areas 124C1 to generate the first structured light SL1. The second partial light beam L2 of the light beam L passes through the first plurality of beam-transmissible areas 122C1 and the third plurality of beam-transmissible areas 124C2 to generate the second structured light SL2.

Specifically, when the first partial light beam L1 of the light beam L passes through the first plurality of beam-transmissible areas 122C1 of the first photogate 122C, the first partial light beam L1 is converted into the first structured light SL1 through the first plurality of beam-transmissible areas 122C1. When the first structured light SL1 continues to advance and is incident on the second plurality of beam-transmissible areas 124C1 of the corresponding second photogate 124C, since the width d124C1 of the second plurality of beam-transmissible areas 124C1 is greater than the width d122C1 of the first plurality of beam-transmissible areas 122C1, the first structured light SL1 may directly penetrate the second plurality of beam-transmissible areas 124C1 and continue to advance along the projection path LP1.

On the other hand, when the second partial light beam L2 of the light beam L passes through the first plurality of beam-transmissible areas 122C1 of the first photogate 122C, the second partial light beam L2 is converted into the first structured light SL1 through the first plurality of beam-transmissible areas 122C1. When the first structured light SL1 continues to advance and is incident on the third plurality of beam-transmissible areas 124C2 of the corresponding second photogate 124C, since the width d124C2 of the third plurality of beam-transmissible areas 124C2 is less than the width d122C1 of the first plurality of beam-transmissible areas 122C1, the first structured light SL1 is further converted into the second structured light SL2 by the third plurality of beam-transmissible areas 124C2. The converted second structured light SL2 continues to advance along the projection path LP1.

As shown in FIG. 4D, the third plurality of beam-transmissible areas 124C2 is opposite to the first plurality of beam-transmissible areas 122C1, and the midpoint of the third plurality of beam-transmissible areas 124C2 is aligned with the midpoint of the opposite second plurality of beam-transmissible areas 124C1, so the first structured light SL1 is aligned with the second plurality of beam-transmissible areas 124C1.

Since the first structured light SL1 is generated in the first plurality of beam-transmissible areas 122C1 of the first photogate 122C located on the light incident surface of the photogate device 120C, the second structured light SL2 is generated in the third plurality of beam-transmissible areas 124C2 in the second photogate 124C located on the light exit surface of the photogate device 120C, and therefore the first structured light SL1 and the second structured light SL2 have different DOF D1 and DOF D2. Moreover, the stripe widths of the first images I11, I12, and I13 formed by the first structured light SL1 are different from the stripe widths of the second images I21, I22, and I23 formed by the second structured light SL2. That is, the stripe widths of the first images are less than the stripe widths of the second images, as shown in FIG. 4A. Since the first image and the second image have different stripe widths, the first image and the second image may be more clearly distinguished from each other.

Therefore, through the width relationship between the first plurality of beam-transmissible areas 122C1, the second plurality of beam-transmissible areas 124C1, and the third plurality of beam-transmissible areas 124C2 having different widths, the light beam L may generate the first structured light SL1 and the second structured light SL2 having different DOFs.

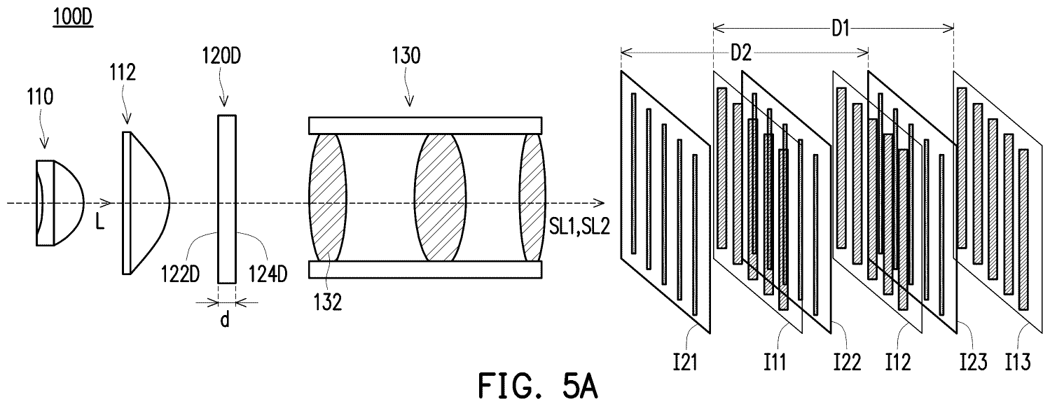

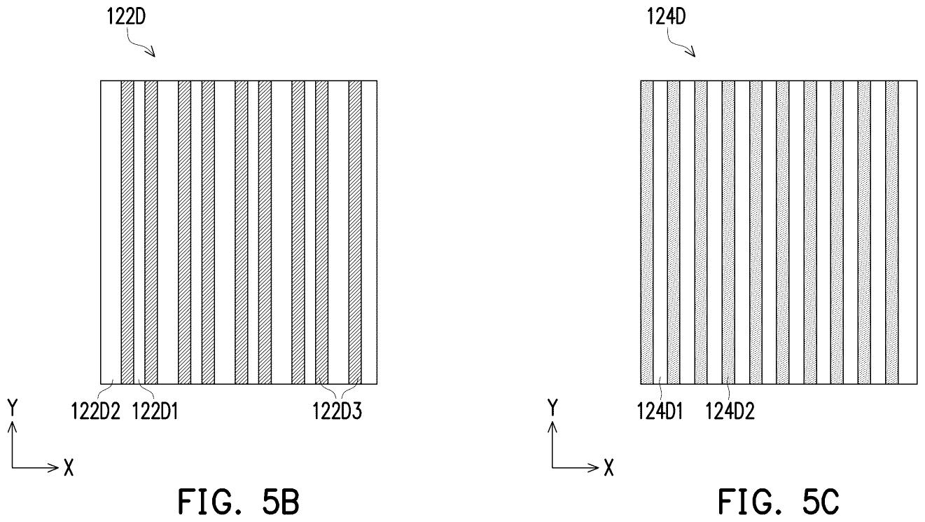

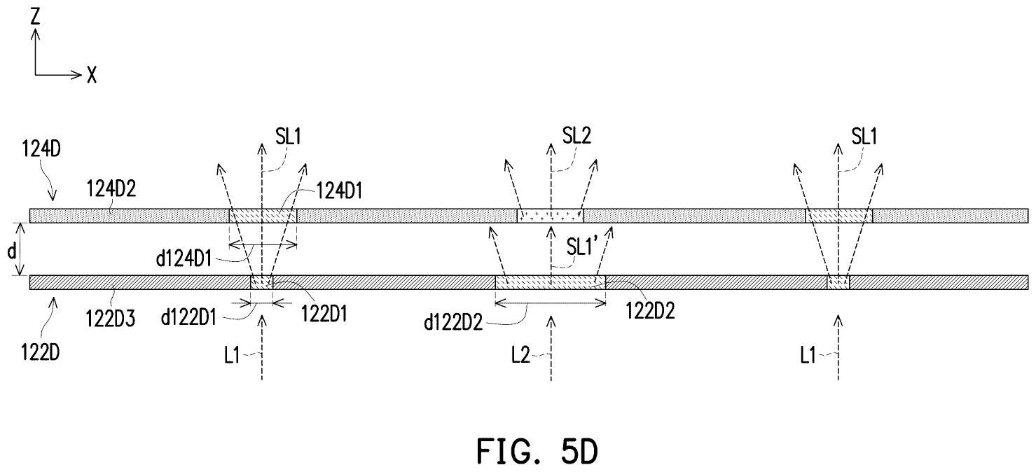

FIG. 5A is a schematic diagram of a projection device according to an embodiment of the present disclosure. The projection device 100D is an embodiment of the projection device 100 in FIG. 1. The projection device 100D shown in FIG. 5A is similar to the projection device 100C shown in FIG. 4A, except that the projection device 100D has a different photogate device 120D relative to the projection device 100C. The photogate device 120D has a first photogate 122D and a second photogate 124D. Therefore, the following describes the differences between the photogate device 120D and the photogate device 120C.

FIG. 5B is a schematic diagram of a first photogate according to an embodiment of the present disclosure. FIG. 5C is a schematic diagram of a second photogate according to an embodiment of the present disclosure. FIG. 5D is a schematic diagram of generating a first structured light and a second structured light according to an embodiment of the present disclosure.

Please refer to FIG. 5B, FIG. 5C, and FIG. 5D at the same time. The first photogate 122D has beam-transmissible areas with two different widths, and the second photogate 124D has a beam-transmissible area with a single width. Specifically, the first photogate 122D includes the first plurality of beam-transmissible areas 122D1, the second plurality of beam-transmissible areas 122D2, and the first plurality of beam-impermeable areas 122D3. The second photogate 124D includes the third plurality of beam-transmissible areas 124D1 and the second plurality of beam-impermeable areas 124D2. The width of each of the first plurality of beam-transmissible areas 122D1 is the first width d122D1, the width of each of the second plurality of beam-transmissible areas 122D2 is the second width d122D2, and the width of each of the third plurality of beam-transmissible areas 124D1 is the third width d124D1, wherein the first width d122D1 is less than the third width d124D1, and the second width d122D2 is greater than the third width d124D1.

According to some embodiments, the ratio of the first width d122D1 to the third width d124D1 (d122D1/d124D1) is less than or equal to 0.8, and the ratio of the second width d122D2 to the third width d124D1 (d122D2/d124D1) is greater than or equal to 1.2, however, the present disclosure is not limited thereto, and may have other ratios according to actual application requirements.

Each beam-transmissible area of the first plurality of beam-transmissible areas 122D1 is opposite to one of the third plurality of beam-transmissible areas 124D1, and each beam-transmissible area of the second plurality of beam-transmissible areas 122D2 is opposite to one of the third plurality of beam-transmissible areas 124D1. Therefore, the light beam passing through one of the first plurality of beam-transmissible areas 122D1 may be correspondingly incident on one of the third plurality of beam-transmissible areas 124D1, and the light beam passing through one of the second plurality of beam-transmissible areas 122D2 may be correspondingly incident on one of the third plurality of beam-transmissible areas 124D1.

Furthermore, as shown in FIG. 5B, each of the first plurality of beam-transmissible areas 122D1 is staggered with each of the second plurality of beam-transmissible areas 122D2.

In some embodiments, the widths of each of the first plurality of beam-impermeable areas 122D3 of the first photogate 122D and the second plurality of beam-impermeable areas 124D2 of the second photogate 124D are the same. In some embodiments, the widths of each of the first plurality of beam-impermeable areas 122D3 and the second plurality of beam-impermeable areas 124D2 are the third width d124D1, which is the same as the width d124D1 of the third plurality of beam-transmissible areas 124D1 of the second photogate 124D. In other embodiments, the widths of each of the first plurality of beam-impermeable areas 122D3 and the second plurality of beam-impermeable areas 124D2 are the same but different from the third width d124D1, that is, different from the width d124D1 of the third plurality of beam-transmissible 124D1 of the second photogate 124D.

Through the width relationship between the first plurality of beam-transmissible areas 122D1 and the second plurality of beam-transmissible areas 122D2 of the first photogate 122D and the third plurality of beam-transmissible areas 124D1 of the second photogate 124D, it is possible to make the light beam L to generate the first structured light SL1 and the second structured light SL2 with different DOFs. The following description takes FIG. 5D as an example.

Please refer to FIG. 5D. The first partial light beam L1 of the light beam L passes through the first plurality of beam-transmissible areas 122D1 and the third plurality of beam-transmissible areas 124D1 to generate the first structured light SL1. The second partial light beam L2 of the light beam L passes through the second plurality of beam-transmissible areas 122D2 and the third plurality of beam-transmissible areas 124D1 to generate the second structured light SL2.

Specifically, when the first partial beam L1 of the light beam L passes through the first plurality of beam-transmissible areas 122D1 of the first photogate 122D, the first partial light beam L1 is converted into the first structured light SL1 through the first plurality of beam-transmissible areas 122D1. When the first structured light SL1 continues to advance and is incident on the third plurality of beam-transmissible areas 124D1 of the corresponding second photogate 124D, since the width d124D1 of the third plurality of beam-transmissible areas 124D1 is greater than the width d122D1 of the first plurality of beam-transmissible areas 122D1, the first structured light SL1 may directly penetrate the third plurality of beam-transmissible areas 124D1 and continue to advance along the projection path LP1.

On the other hand, when the second partial light beam L2 of the light beam L passes through the second plurality of beam-transmissible areas 122D2 of the first photogate 122D, the second partial light beam L2 is converted into the second temporary structured light SL2′ through the second plurality of beam-transmissible areas 122D2. When the second temporary structured light SL2′ continues to advance and is incident on the third plurality of beam-transmissible areas 124D1 of the corresponding second photogate 124D, since the width d124D1 of the third plurality of beam-transmissible areas 124D1 is less than the width d122D2 of the second plurality of beam-transmissible areas 122D2, the second temporary structured light SL2′ is further converted into the second structured light SL2 by the third plurality of beam-transmissible areas 124D1. The converted second structured light SL2 continues to advance along the projection path LPL.

Since the first structured light SL1 is generated in the first plurality of beam-transmissible areas 122C1 in the first photogate 122D located on the light incident surface of the photogate device 120D, the second structured light SL2 is generated in the third plurality of beam-transmissible areas 124D1 in the second photogate 124D located in the light exit surface of the photogate device 120D, the first structured light SL1 and the second structured light SL2 have different DOF D1 and DOF D2. Moreover, the stripe widths of the first images I11, I12, and I13 formed by the first structured light SL1 are different from the stripe widths of the second images I21, I22, and I23 formed by the second structured light SL2, that is, the stripe widths of the first images are less than the stripe widths of the second images as shown in FIG. 5A. Since the first image and the second image have different stripe widths, the first image and the second image may be more clearly distinguished from each other.

Therefore, through the width relationship between the first plurality of beam-transmissible areas 122D1, the second plurality of beam-transmissible areas 122D2, and the third plurality of beam-transmissible areas 124D1 having different widths, it is possible to make the light beam L to generate the first structured light SL1 and the second structured light SL2 with different DOFs.

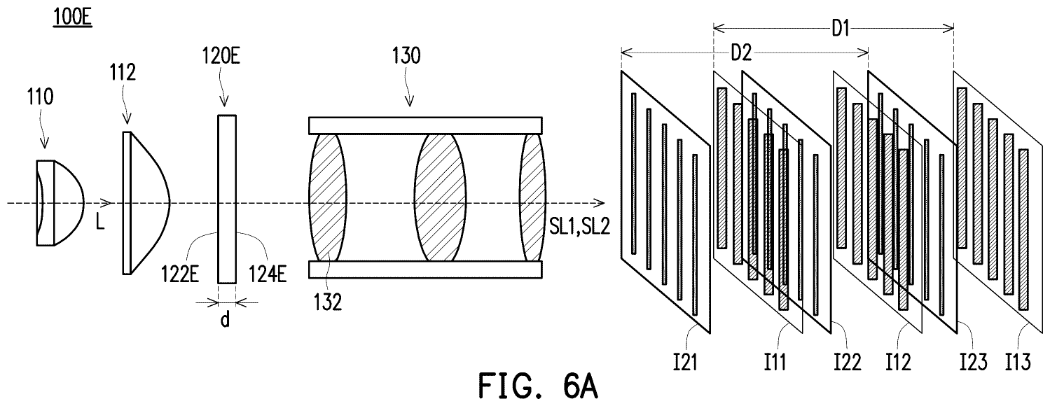

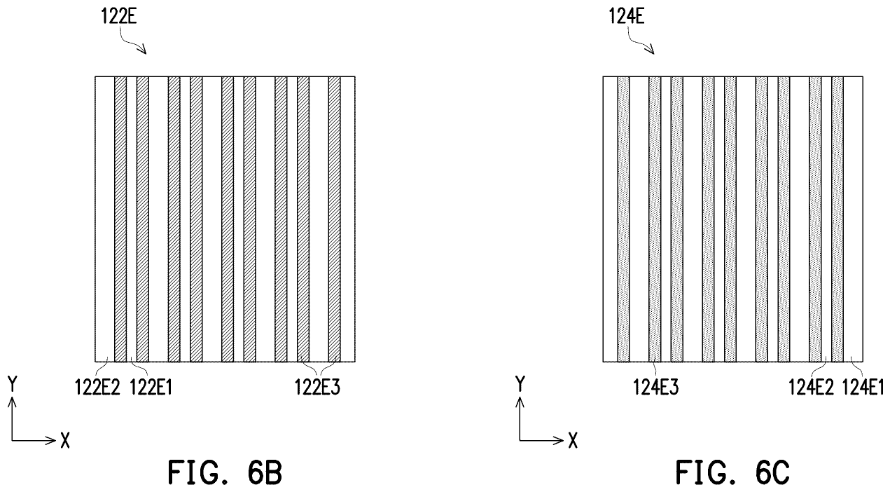

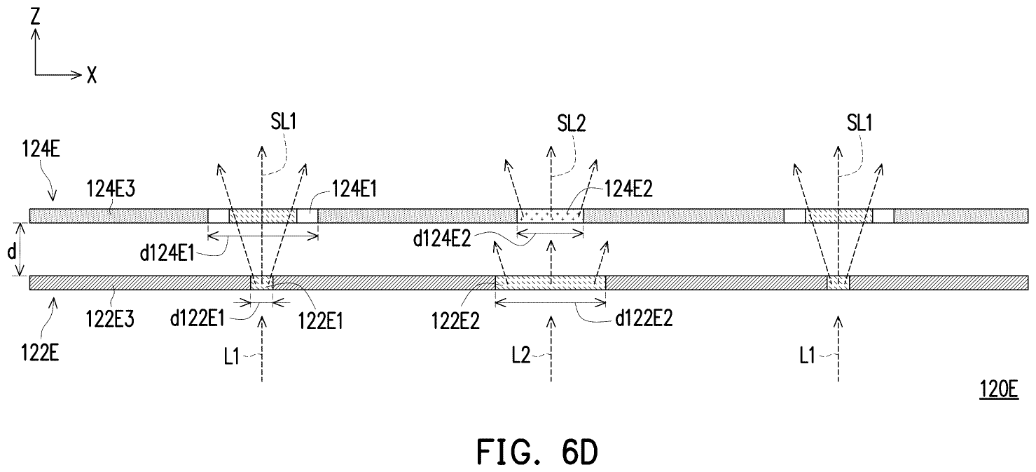

FIG. 6A is a schematic diagram of a projection device according to an embodiment of the present disclosure. The projection device 100E is an embodiment of the projection device 100 in FIG. 1. The projection device 100E shown in FIG. 6A is similar to the projection device 100C shown in FIG. 4A, except that the projection device 100E has a different photogate device 120E relative to the projection device 100E. The photogate device 120E has a first photogate 122E and a second photogate 124E. Therefore, the following describes the differences between the photogate device 120E and the photogate device 120C.

FIG. 6B is a schematic diagram of a first photogate according to an embodiment of the present disclosure. FIG. 6C is a schematic diagram of a second photogate according to an embodiment of the present disclosure. FIG. 6D is a schematic diagram of generating a first structured light and a second structured light according to an embodiment of the present disclosure.

Please refer to FIG. 6B, FIG. 6C, and FIG. 6D at the same time. The first photogate 122E has beam-transmissible areas with two different widths, and the second photogate 124E has beam-transmissible areas with two different widths. Specifically, the first photogate 122E includes the first plurality of beam-transmissible areas 122E1, the second plurality of beam-transmissible areas 122E2, and the first plurality of beam-impermeable areas 122E3. The second photogate 124E includes a third plurality of beam-transmissible areas 124E1, a fourth plurality of beam-transmissible areas 124E2, and a second plurality of beam-impermeable areas 124E3. The width of each of the first plurality of beam-transmissible areas 122E1 is the first width d122E1, the width of each of the second plurality of beam-transmissible areas 122E2 is the second width d122E2, the width of each of the third plurality of beam-transmissible areas 124E1 is the third width d124E1, and the width of each of the fourth plurality of beam-transmissible areas 124E2 is the fourth width d124E2, wherein the first width d122E1 is less than the third width d124E1, and the second width d122E2 is greater than the fourth width d124E2. In some embodiments, the first width d122E1 is equal to the fourth width d124E2, and the second width d122E2 is equal to the third width d124E1.

According to some embodiments, the ratio of the first width d122E1 to the third width d124E1 is less than or equal to 0.8, and the ratio of the second width d122E2 to the fourth width d124E2 is greater than or equal to 1.2, but the disclosure is not limited thereto; there may be other ratios depending on actual application requirements.

In addition, as shown in FIG. 6B, each of the first plurality of beam-transmissible areas 122E1 is staggered with each of the second plurality of beam-transmissible areas 122E2.

In addition, as shown in FIG. 6C, each of the third plurality of beam-transmissible areas 124E1 is staggered with each of the fourth plurality of beam-transmissible areas 124E2.

In some embodiments, the widths of each of the first plurality of beam-impermeable areas 122E3 of the first photogate 122E and the second plurality of beam-impermeable areas 124E3 of the second photogate 124E are the same.

Through the width relationship between the first plurality of beam-transmissible areas 122E1, the second plurality of beam-transmissible areas 122E2, the third plurality of beam-transmissible areas 124E1, and the fourth plurality of beam transmissible areas 124E2, it is possible to make the light beam L to generate the first structured light SL1 and the second structured light SL2 with different DOFs. The following description takes FIG. 6D as an example.

Please refer to FIG. 6D. The first partial light beam L1 of the light beam L passes through the first plurality of beam-transmissible areas 122E1 and the third plurality of beam-transmissible areas 124E1 to generate the first structured light SL1. The second partial light beam L2 of the light beam L passes through the second plurality of beam-transmissible areas 122E2 and the third plurality of beam-transmissible areas 124E1 to generate the second structured light SL2.

Specifically, when the first partial light beam L1 of the light beam L passes through the first plurality of beam-transmissible areas 122E1 of the first photogate 122E, the first partial light beam L1 is converted into the first structured light SL1 through the first plurality of beam-transmissible areas 122E1. When the first structured light SL1 continues to advance and is incident on the third plurality of beam-transmissible areas 124E1 of the corresponding second photogate 124E, since the width d124E1 of the third plurality of beam-transmissible areas 124E1 is greater than the width d122E1 of the first plurality of beam-transmissible areas 122E1, the first structured light SL1 may directly penetrate the third plurality of beam-transmissible areas 124E1 and continue to advance along the projection path LP1.

On the other hand, when the second partial light beam L2 of the light beam L passes through the second plurality of beam-transmissible areas 122E2 of the first photogate 122E, the second partial light beam L2 is converted into the second temporary structured light SL2′ through the second plurality of beam-transmissible areas 122E2. When the second temporary structured light SL2′ continues to advance and is incident on the fourth plurality of beam-transmissible areas 124E2 of the corresponding second photogate 124E, since the width d124E2 of the fourth plurality of beam-transmissible areas 124E2 is less than the width d122E2 of the second plurality of beam-transmissible areas 122E2, the second temporary structured light SL2′ is further converted into the second structured light SL2 by the fourth plurality of beam-transmissible areas 124E2. The converted second structured light SL2 continues to advance along the projection path LPL.

Since the first structured light SL1 is generated in the first plurality of beam-transmissible areas 122E1 in the first photogate 122E located on the light incident surface of the photogate device 120E, the second structured light SL2 is generated in the fourth plurality of beam-transmissible areas 124E2 in the second photogate 124E located on the light exit surface of the photogate device 120E, and the first structured light SL1 and the second structured light SL2 have different DOF D1 and DOF D2. Moreover, the stripe widths of the first images I11, I12, and I13 formed by the first structured light SL1 are different from the stripe widths of the second images I21, I22, and I23 formed by the second structured light SL2, that is, the stripe widths of the first images are less than the stripe widths of the second images as shown in FIG. 6A. Since the first image and the second image have different stripe widths, the first image and the second image may be more clearly distinguished from each other.

Therefore, through the width relationship between the first plurality of beam-transmissible areas 122D1, the second plurality of beam-transmissible areas 122D2, the third plurality of beam-transmissible areas 124D1 and the fourth plurality of beam-transmissible areas 124E2 having different widths, it is possible to make the light beam L to generate the first structured light SL1 and the second structured light SL2 with different DOFs.

In summary, the present disclosure may simultaneously generate two structured lights with different DOFs by controlling the shapes of the first photogate and the second photogate. Therefore, the DOF of the system may be improved while maintaining brightness.

What is claimed is:

1. An illuminating device, comprising:
a projection device, comprising:
a light source configured to generate a light beam;
a photogate device located on an optical path of the light beam, the photogate device comprising:
a first photogate located on a light incident surface of the photogate device; and
a second photogate located on a light exit surface of the photogate device,
wherein the light beam passes through the first photogate and the second photogate in sequence, the light beam passes through the first photogate to generate a first structured light, the light beam passes through the second photogate to generate a second structured light, the first structured light and the second structured light are projected to an object to be detected through a projection path;
a light receiving device configured to sense a first image light and a second image light of the object to be detected through a sensing path when the first structured light and the second structured light are projected to the object to be detected;
a processor coupled to the light receiving device for analyzing a first image and a second image of the object to be detected, wherein the first image corresponds to the first image light of the object to be detected, and the second image corresponds to the second image light of the object to be detected.

2. The illuminating device according to claim 1, wherein the first structured light has a first depth of field (DOF), and the second structured light has a second DOF that is different from the first DOF.

3. The illuminating device according to claim 1, wherein the first photogate comprises a first pattern area and a second pattern area, the second photogate comprises a third pattern area and a fourth pattern area, and a first part of the light beam passes through the first pattern area and the third pattern area to generate the first structured light, and a second part of the light beam passes through the second pattern area and the fourth pattern area to generate the second structured light.

4. The illuminating device according to claim 3, wherein the first pattern area has a first pattern to generate the first structured light, and the fourth pattern area has a second pattern to generate the second structured light, the second pattern area and the third pattern area allow the light beam to pass through.

5. The illuminating device according to claim 4, wherein the first pattern and the second pattern are the same patterns.

6. The illuminating device according to claim 4, wherein the first pattern and the second pattern are stripe patterns perpendicular to an optical path direction.

7. The illuminating device according to claim 6, wherein an extending direction of the first pattern is parallel or perpendicular to an extending direction of the second pattern.

8. The illuminating device according to claim 6, wherein a gap of the stripe pattern of the first pattern is the same as a gap of the stripe pattern of the second pattern.

9. The illuminating device according to claim 4, wherein the first pattern and the second pattern are different patterns.

10. The illuminating device according to claim 1, wherein the first photogate comprises a first plurality of beam-transmissible areas and a first plurality of beam-impermeable areas, and the second photogate comprises a second plurality of beam-transmissible areas, a third plurality of beam-transmissible areas and a second plurality of beam-impermeable areas,
wherein a width of each of the first plurality of beam-transmissible areas is a first width, a width of each of the second plurality of beam-transmissible areas is a second width, and a width of each of the third plurality of beam-transmissible areas is a third width,
wherein the second width is greater than the first width, the third width is less than the first width,
a first part of the light beam passes through the first plurality of beam-transmissible areas and the second plurality of beam-transmissible areas to generate the first structured light, a second part of the light beam passes through the first plurality of beam-transmissible areas and the third plurality of beam-transmissible areas to generate the second structured light.

11. The illuminating device according to claim 10, wherein a ratio of the second width to the first width is greater than or equal to 1.2, and a ratio of the third width to the first width is less than or equal to 0.8.

12. The illuminating device according to claim 10, wherein widths of each of the first plurality of beam-impermeable areas and the second plurality of beam-impermeable areas are the same.

13. The illuminating device according to claim 10, wherein widths of each of the first plurality of beam-impermeable areas and the second plurality of beam-impermeable areas are the first width.

14. The illuminating device according to claim 10, wherein each of the second plurality of beam-transmissible areas is staggered with each of the third plurality of beam-transmissible areas.

15. The illuminating device according to claim 1, wherein the first photogate comprises a first plurality of beam-transmissible areas, a second plurality of beam-transmissible areas and a first plurality of beam-impermeable areas, and the second photogate comprises a third plurality of beam-transmissible areas and a second plurality of beam-impermeable areas,
wherein a width of each of the first plurality of beam-transmissible areas is a first width, and a width of each of the second plurality of beam-transmissible areas is a second width, a width of each of the third plurality of beam-transmissible areas is a third width,
wherein the first width is less than the third width, the second width is greater than the third width,
a first part of the light beam passes through the first plurality of beam-transmissible areas and the third plurality of beam-transmissible areas to generate the first structured light, and a second part of the light beam passes through the second plurality of beam-transmissible areas and the third plurality of beam-transmissible areas to generate the second structured light.

16. The illuminating device according to claim 15, wherein widths of each of the first plurality of beam-impermeable areas and the second plurality of beam-impermeable areas are the same.

17. The illuminating device according to claim 15, wherein widths of each of the first plurality of beam-impermeable areas and the second plurality of beam-impermeable areas are the third width.

18. The illuminating device according to claim 15, wherein each of the first plurality of beam-transmissible areas is staggered with each of the second plurality of beam-transmissible areas.

19. The illuminating device according to claim 1, wherein a thickness of the photogate device in an optical path direction is 0.5 mm to 2 mm.

20. The illuminating device according to claim 1, wherein the light beam is an infrared light, a red light, a green light, a blue light, a near-ultraviolet light, an ultraviolet light, or a white light.
